(19) United States
(12) Patent Application Publication
(10) Pub. No.: US 2011/0264678 A1
(43) Pub. Date: Oct. 27, 2011

(54) USER MODIFICATION OF A MODEL APPLIED TO SEARCH RESULTS

(75) Inventors: Vijay Mital, Kirkland, WA (US); Thomas Frank Bergstraesser, Kirkland, WA (US); Darryl Ellis Rubin, Duvall, WA (US)

(73) Assignee: Microsoft Corporation, Redmond, WA (US)

(21) Appl. No.: 12/767,211

(22) Filed: Apr. 26, 2010

(51) Int. Cl. G06F 17/30

(52) U.S. Cl. 707/759; 707/769; 707/E17.062

(57) ABSTRACT

A data search and retrieval system that, in response to a search query, applies a model to search results to generate information to be returned to a user. A user may modify the model via a set of controls displayed to the user. The modified model may then be applied to search results to generate information in compliance with the modified model. Modified models may be stored locally on a client system or stored in the search system and made available to other users so that the modified models can be applied to subsequent requests for information. The modified models and the results of a search may be stored on a client machine such that, as the model is modified, new information may be generated based on the original search, reducing communication bandwidth, which can improve the speed and cost of providing user interaction with data in a mobile environment.

### BACKGROUND

With the widespread availability of information over networks, such as the Internet, search engines have come into widespread use. Search engines receive user queries and find content matching the query to return to the user. A common approach to implementing a search engine is through a page index. The page index relates terms that may appear in a search query to units of content on the network, frequently called web pages.

Various approaches exist for constructing and applying the page index. Constructing the index frequently entails “crawling” a network, such as the Internet, containing the body of data that will eventually be searched. Crawling entails following links from one web page to the next and analyzing each page. As part of the analysis, terms characterizing the web page may be identified and added to the page index in a way that associates that web page with those terms. These terms may be terms actually used within the context displayed by the web page or may be tags added specifically to influence how the crawler indexes the web page. Additionally, information, such as the number of links to a web page, may be captured and used to prioritize the web pages.

The page index is applied as part of a search stack. When a user submits a search query, a search engine matches terms in the query to web pages based on the search index. The search stack may include components that modify the search query before the index is consulted, such as to correct misspelling of search terms or attach terms that can be inferred based on a user profile. The search stack may also include components to filter search results. For example, web pages identified using the page index may be filtered, such as by ranking the web pages based on a metric indicating relevance to a query.

In scenarios in which search queries seeking information that may not appear directly on a web page are anticipated, information may be pre-computed. An entry may be made in the page index, pointing to the pre-computed information rather than a web page.

### SUMMARY

The usefulness of a search system may be improved by incorporating into a search stack of the system components that may select and apply a model characterizing information to be provided in response to a search query. The model may be selected from a set of models based on user context information, such as a search query from a user and/or data identified by a search engine in response to the search query. Application of the model may result in generation of new information, in addition to formatting, filtering or processing data returned by a search engine executing the query.

A user may modify a model via a set of controls displayed to the user. Modifications to the model may be made available to the search system, and the modified model may then be applied to search results to generate information in compliance with the modified model. Such modified models may be stored locally on a client system or stored in the search system and made available to other users so that the modified models can be applied to subsequent requests for information.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high level block diagram illustrating a computing environment in which some embodiments of the invention may be practiced;

FIG. 2 is an architectural block diagram of a search stack according to some embodiments;

FIG. 3 is a diagram of types of statements that may comprise the specification of a declarative model;

FIG. 4 is a diagram of an example of statements, such as those that may be specified for the declarative model of FIG. 3;

FIG. 5 is a flowchart of a process that may be performed during execution by a search stack, according to some embodiments;

FIG. 6 is an example of a user interface via which a user may enter a search query and display information returned in response to the query;

FIG. 7A is an example of a user interface via which a user may modify a model applied to generate information returned in response to a search query;

FIG. 7B is an example of the user interface of FIG. 7A illustrating the application of a modified model to the generation of information returned to the user;

FIG. 8 is a flowchart of a process of modifying a model that may be carried out by an information retrieval system; and

FIG. 9 is a flowchart of a process of modifying a model that may be carried out by a client of an information retrieval system.

### DETAILED DESCRIPTION

The inventors have recognized and appreciated that functionality and utility of search systems may be expanded by incorporating into a search stack of a search system components that can select and apply one or more models characterizing data to be provided to a user in the user's context. The application of a model may also affect the manner in which the user may interface with data provided to the user. In response to a search query, or other input identifying user context, the system may identify a model to apply in generating information for the user. The model may be selected based on user context information, that may include the search query itself or data generated by a search engine applying the search query to select web pages.

Once a model is selected, a model application engine may apply the model to generate information to be provided to the user. A model may include one or more elements, at least some of which define a computation to be performed based on data dynamically identified for the user's context. For example, application of the model may result in a computation that has inputs relating to terms in the search query or data generated by a search engine applying the search query. The output of the computation may be provided to the user as a result of the search query, either alone or in conjunction with data located by a search engine or other dynamically generated data.

In some embodiments, the computation may be based on an equation represented in the model. The equation may specify a mathematical operation to be performed on data that is dynamically identified by the search engine. Such a mathematical operation may include other data, such as user data obtained from a user profile or based on context information. Applying models in a search stack may greatly expand the type of information that may be returned to a user and may be applied in many different contexts.

For example, a model may include an equation, defining computation of calorie content from a recipe. Such a model may be applied in response to a query requesting recipes such that, in addition to receiving content representing recipes found on web pages, a user may receive calorie content, even though that information was not included on the web pages. Such a model may provide the ability for the user to interact with the information retrieval system with or without going back to the search engine, e.g. by allowing the user to specify or change his personal profile and nutrition goals and see alternative meal plans for the day that are generated by applying a modified model to information previously generated by a search engine.

As another example, a model may include a formula for computing commuting distance or time from a location. Such a model may be applied in response to a query requesting information on houses for sale such that, in addition to receiving a listing of houses for sale identified as a result of a search, a user may receive commuting information with each house. A system may support user edits to the commuting model to let the user interact with and do “what-ifs” with the information, e.g. the commuting impact of particular school/gym/workplace/transportation mode choices.

As yet another example, a model may include a formula for generating a metric comparing a patient's lab results to a population norm. Such a model may be applied in a search system coupled to an intranet in a hospital such that, when a search is conducted for lab results of a patient, a clinician may receive, in addition to lab results for the patient, comparative data characterizing the results based on an analysis of lab results in medical records for other users returned as a result of the search. The model may enable the clinician to do what-ifs like change some assumptions about the patient or the relationship between lab data and underlying disease.

In a further example, a model may contain rules that characterize fashion preferences (e.g., style, cut, color, etc.). Such a model may be applied in response to search results generated based on a search query for “evening dresses,” such that a list of dresses for purchase is returned to the user in response to the query, in which the returned list of dresses is in compliance with the fashion preferences of the applied model.

A search system may contain multiple models, applicable in different contexts. Accordingly, a search system may contain a component that selects a model for a specific context. A component to perform this function may access a model index. In some embodiments, the model index may have a form analogous to a page index used by a search engine. In this way, existing techniques optimized for high speed search may also be used to quickly select and apply a model. Such an approach may be useful in scenarios in which a model is identified based on terms or other aspects of a search query. Further, in some embodiments, the models may be treated as web pages and may include meta tags to aid in indexing them in a search engine.

To facilitate the use of models, each model may be represented as a collection of declarative statements (“expressions”). An expression may be a symbolic representation of a computation to be performed, which may comprise operators and operands. The operators of an expression may include any operators known to one of skill in the art (such as the common mathematical operators of addition, subtraction, multiplication, and division), any functions known to one of skill in the art, and functions defined by a user. The operands of an expression may include data (such as numbers or strings), symbols that represent data, and other expressions. An expression may thus be recursive in that an expression may be defined by other expressions.

A symbol may represent any type of data used in common programming languages or known to one of skill in the art. For example, a symbol may represent an integer, a rational number, a string, a Boolean, a sequence of data (potentially infinite), a tuple, or a record. In some embodiments, a symbol may also represent irrational numbers, while in other embodiments, symbols may not be able to represent irrational numbers.

For example, an expression may take the form of a symbolic representation of an algebraic expression, such as x²+2xy+y², where x and y may be symbols that represent data or other expressions. An expression may take the form of an equation, such as E=mc², where E, m, and c may by symbols representing data or other expressions. An expression may take the form of a function definition, such as ƒ(x)=x²−1, where ƒ is a symbol representing the function, x is a symbol representing an operand or argument of the function, and x²−1 is an expression that defines the function. An expression may also take the form of a function invocation, such as ƒ(3), which indicates that the function ƒ is to be invoked with an argument of 3.

Expressions may be solved by an expression engine to produce a result. For example, where the symbol x (itself an expression) represents the number 3 and the symbol y (also an expression) represents the number 2, the expression x²+2xy+y² may be solved by replacing the symbols with the values the represent, e.g., 2²+2×2×3+3², and then applying the operators to the operands to solve the entire expression as 25. In another example, where m is a symbol representing the number 2 and c is a symbol representing the number 3, the expression E, defined above, may be solved by replacing E with its definition, e.g., mc², replacing the symbols m and c with the values they represent, e.g., 2×3², and applying the operators to the operands to solve the expression as 18.

In evaluating an expression, the expression engine may apply the operators to the operands to the extent that the operators and operands are defined and to the extent that expression engine knows how to apply the operators to the operands. For example, where the symbol x represents the number 3 and the symbol y is not defined, the expression x²+2xy+y² may be solved by replacing the known symbols with the values the represent, e.g., 2²+2×2×y+y², and then applying the operators to the operands to solve the entire expression as 4+4y+y². Where the symbol x represents the number 3 and the symbol y represents the string “hello”, the expression x²+2xy+y² may be solved as 4+4×hello+hello², since the expression engine may not know how to perform arithmetic operations on the string “hello.”

In some embodiments, expressions may be declarative. A declarative expression may indicate a computation to be performed without specifying how to compute it. A declarative expression may be contrasted with an imperative expression, which may provide an algorithm for a desired result.

In some embodiments, expressions may be immutable. An expression is immutable if it cannot be changed. For example, once a definition is given, such as E=mc², the expression E cannot later be given a different definition. One advantage of immutability is that applications defined by immutable expressions may be side-effect free in that the functionality of the application may not be able to be altered by users of the application.

An application may be defined by a set of expressions, aka a model. An application defined by expressions may have input variables and output variables and the relationship between the input variables and the output variables may be defined by the set of expressions that defines the application. The determination of which variables are input variables and which variables are output variables may be determined by the user. In solving for the output variables, the expression engine may produce data (e.g., a number or a string) or may produce an expression of the input variables.

In this way, the models may be relatively easy to produce and apply. Further, by having the models applied in a model engine, an entity providing search services may receive models from third parties and apply them in an environment in which application of the model cannot interfere with operation of the computer equipment that implements the search system.

As a result, knowledge useful in generating search results may be captured in models and shared across search systems. Further, by allowing the models to be applied in the search stack of a search system, models may perform computations or other operations based on data that is only available within the search system.

The inventors have further appreciated that it may be useful to allow users of the search system to modify a model that may be applied to search results. User inputs may specify aspects of the model that modify the nature of information returned to the user when the model is applied. Modifications to the model may be made available to the search system, and the modified model may then be applied to search results to generate information in compliance with the modified model. The modifications may be made via editing controls displayed in a user interface. For example, the controls may allow a user to enter an expression in a text input field. The entered expression may comprise an addition to a specification for the model. As another example, the controls may allow a user to vary aspects of the specification of the model (e.g., in the fashion preferences example, the user may vary dress prices, color makeup, a formality of the dress in a continuum from “formal” to “casual,” etc.).

Thus, by modifying an existing model, a user may further customize information returned in response to a request for information (e.g., search query) to better correspond to the user's current needs and/or interests. Such modified models may be stored locally on a client system or stored in the search system and made available to other users so that the modified models can be applied again to subsequent requests for information.

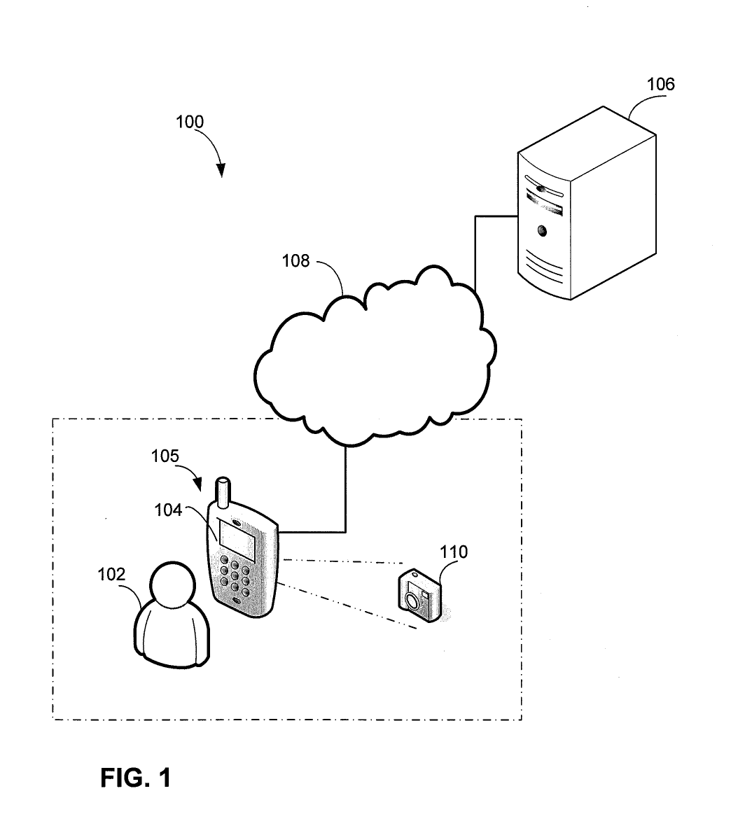

FIG. 1 is a high level diagram illustrating a computing environment 100 in which some embodiments of the invention may be practiced. Computing environment 100 includes a user 102 interacting with a computing device 105. Computing device 105 may be any suitable computing device, such as a desktop computer, a laptop computer, a mobile phone, or a PDA. Computing device 105 may operate under any suitable computing architecture, and include any suitable operating system, such as variants of the WINDOWS® Operating System developed by MICROSOFT® Corporation.

Computing device 105 may have the capability to communicate over any suitable wired or wireless communications medium to a server 106. The communication between computing device 105 and server 106 may be over computer network(s) 108, which may be any suitable number or type of telecommunications networks, such as the Internet, a corporate intranet, or cellular networks. Server 106 may be implemented using any suitable computing architecture, and may configured with any suitable operating system, such as variants of the WINDOWS® Operating System developed by MICROSOFT® Corporation. Moreover, while server 106 is illustrated in FIG. 1 as being a single computer, it may be any suitable number of computers configured to operate as a coherent system.

In the example of FIG. 1, server 106 operates as a search engine, allowing user 102 to retrieve information relevant to a search query. The user may specify the query explicitly, such as by inputting query terms into computing device 105 in any suitable way, such as via a keyboard, key pad, mouse, or voice input. Additionally and/or alternatively, the user may provide an implicit query. For example, computing device 105 may be equipped with (or connected via a wired or wireless connection to) a digital camera 110. An image, such as of an object, a scene, or a barcode scan, taken from digital camera 110 may serve as an implicit query.

Regardless of the type of input provided by user 102 that triggers generation of a query, computing device 105 may send the query to server 106 to obtain information relevant to the query. After retrieving data relevant to the search query, such as, for example, web pages, server 106 may apply one or more declarative models to the data to generate higher level information to be returned to user 102. The information generated by server 106 may be sent over computer network(s) 108 and be displayed on display 104 of computing device 105. Display 104 may be any suitable display, including an LCD or CRT display, and may be either internal or external to computing device 105.

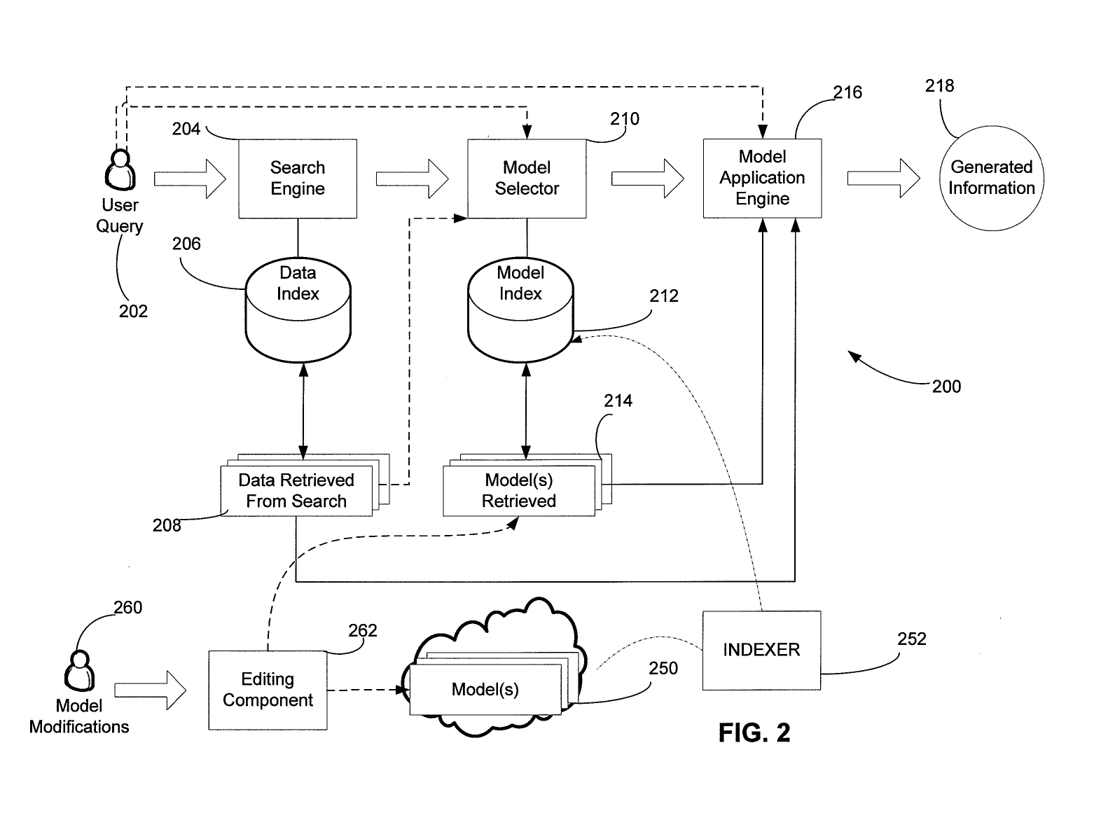

FIG. 2 is an architectural block diagram of a search stack 200 according to some embodiments, such as may be implemented by server 106 of FIG. 1. The components of search stack 200 may be implemented using any suitable configuration and number of computing devices, such as for purposes of load-balancing or redundancy. For example, the functionality described in connection with each component of the search stack may be performed by different physical computers configured to act as a coherent system, and/or a single physical computer may perform the functionality ascribed to multiple components. In addition, in some embodiments, some of the functionality ascribed to a single component of the search stack may be distributed to multiple physical computers, each of which may perform a different portion of the computation in parallel.

Regardless of the specific configuration of search stack 200, a user query 202 may be provided as input to search stack 200 over a computer networking communications medium, and may be either implicit or explicit, as discussed in connection with FIG. 1. In the example of FIG. 2, user query 200 is provided to an input component in search stack 200, such as search engine 204, which may be any suitable search engine, such as the BING® search engine developed by Microsoft Corporation. Search engine 204 may be coupled to one or more storage media comprising a data index 206. Data index 206 may be stored on any suitable storage media, including internal or locally attached media, such as a hard disk, storage connected through a storage area network (SAN), or networked attached storage (NAS). Data index 206 may be in any suitable format, including one or more unstructured text files, or one or more relational databases.

Search engine 204 may consult data index 206 to retrieve data 208 related to the user query 202. The retrieved data 208 may be a data portion of search results that are retrieved based on user query 202 and/or other factors relevant to the search, such as a user profile or user context. That is, data index 206 may comprise a mapping between one or more factors relevant to a search query (e.g., user query terms, user profile, user context) and data, such as data pages, that match and/or relate to that query. The mapping in data index 206 may be implemented using conventional techniques or in any other suitable way.

Regardless of the type of mapping performed using data index 206 to retrieve data 208 relevant to the search, data 208 may comprise any suitable data retrieved by search engine 204 from a large body of data, such as, for example, web pages, medical records, lab test results, financial data, demographic data, video data (e.g., angiograms, ultrasounds), or image data (e.g., x-rays, EKGs, VQ scans, CT scans, or MRI scans). Data 208 may be retrieved or identified dynamically by search engine 204 or it may be cached as the result of a prior search performed by search engine 204 based on similar or identical query. Data 208 may be retrieved using conventional techniques or in any other suitable way.

The search stack 200 may also include a model selection component, such as model selector 210, which may select one or more appropriate declarative model(s) 214 from a set of models stored on one or more computer readable media accessible to the model selector 210. The model selector 210 may then apply the selected model(s) 214 to the results (i.e., data 208) of the search performed by search engine 204, Model selector 210 may be coupled to model index 212, which may be the same as data index 206 or may be a separate index. Model index 212 may be implemented on any suitable storage media, including those described in connection with data index 206, and may be in any suitable format, including those described in connection with data index 206. Model index 212 may comprise a mapping between one or more factors relevant to the user's search (e.g., terms in user query 202, user profile, user context, and/or the data 208 retrieved by the search engine 204) and appropriate model(s) 214 that may be applied to the data 208 retrieved by search engine 204.

Selected models 214 may be selected from a larger pool of models 250 stored on computer-readable media associated with server 106 (FIG. 1). In some embodiments, pool of models 250 may be supplied by an entity operating the search system. Though, in other embodiments, all or a portion of the models in pool of models 250 from which models 214 are selected may be provided by parties other than the entity operating the search system. In some embodiments, models in pool of models 250 may be supplied by a user inputting user query 202. In such a scenario, a portion of pool of models 250 accessed by model selector 210 may include computer storage media segregated to store data personal to individual users, such as the user submitting user query 202. In other embodiments, a community of users may have access to the search system and pool of models 250 may include models submitted by users other than the user who submitted user query 202. In yet other embodiments, some or all of the models in pool of models 250 from which models 214 were selected may be provided by other third parties. Such third parties may include businesses or organizations that have a specialized desire or ability to specify the nature of information to be generated in response to a search query. For example, a model that computes commuting distance from a house for sale may be provided by a real estate agent. A model that computes comparative lab results may be provided by a medical association. Accordingly, it should be appreciated that any number or type of models may be incorporated in pool of models 250.

In some embodiments, to facilitate easy addition of models to pool of models 250, the search system illustrated in FIG. 2 may include an indexer 252. Indexer 252 may update model index 212 based on models contained within pool of models 250. In some embodiments, each of the models in pool of models 250 may contain meta tags identifying context in which the model may be applied. Indexer 252 may use this information similar to meta tags attached to web pages to construct model index 212. In this regard, indexer 252 may be implemented using technology known in the art for implementing a web crawler to build a page index. To support such an implementation, each of the models in pool of models 250 may be formatted as a web page. However, it should be recognized that any suitable technique may be used for constructing model index 212, including machine learning techniques or explicit human input. Model selector 210 may be implemented using technology known in the art for implementing a search engine based upon an index. However, rather than identifying which pages to return to a user based on a data index, model selector 210 may employ model index 212 to identify models used in generating information to provide to a user. Model selector 210 may identify models based on a precise match between factors relevant to the search and terms in the model index. Though, inexact matching techniques may alternatively or additionally be used. In some embodiments, the declarative models are themselves stored in model index 212, while in other embodiments, the models themselves may be stored separately from model index 212, but in such a way that they may be appropriately identified in model index 212.

Search stack 200 may also include a model application engine 216, which may apply the selected model(s) 214 to the data 208 retrieved by search engine 204. In the application of a model, data 208 may serve as a parameter over which the selected model(s) is applied by model application engine 216. Additional parameters, such as portions of user query 202, may also be provided as input to the selected model(s) during model application. Though, it should be appreciated that any data available within the search environment illustrated in FIG. 2 may be identified in a model or used by model application engine 216 when the model is applied.

As a result of the application of the model to the search results performed by model application engine 216, information 218 may be generated. Generated information 218 may be returned to the user by an output component (not shown) of search stack 200. Though, the generated information may be used in any suitable way, including as a query for further searching by search engine 204. Generated information 218 may include the results of model application performed by model application engine 216, may include data 208 retrieved by the search engine 204, or any suitable combination thereof. For example, based on the application of a model performed by the model application engine 216, the ordering of the presentation to a user of data 208 may change, the content presented as part of data 208 may be modified so that it includes additional or alternative content that is the result of a computation performed by model application engine 216, or any suitable combination of the two. Thus, when selected model(s) 214 are applied to raw data, such as data 208, retrieved by a search engine, the generated information 218 may be at a higher level of abstraction and therefore be more useful to a user than the raw data itself.

Search stack 200 may also include a model editing component 262. Model editing component 262 may receive model modifications 260, which may have been provided by a user. Model modifications 260 may comprise edits to an existing model, such as one of the models in pool of models 250. In some embodiments, model modifications 260 may comprise modifications to one of selected model(s) 214 that may have been applied as part of generating information 218 in response to a prior user query 202. Based on model modifications 260, model editing component 262 may modify the referenced model in pool of models 250 and/or create a new model corresponding to the user inputs, and store the new model in pool of models 250. The modified model may then be applied to generate information in response to subsequent search queries.

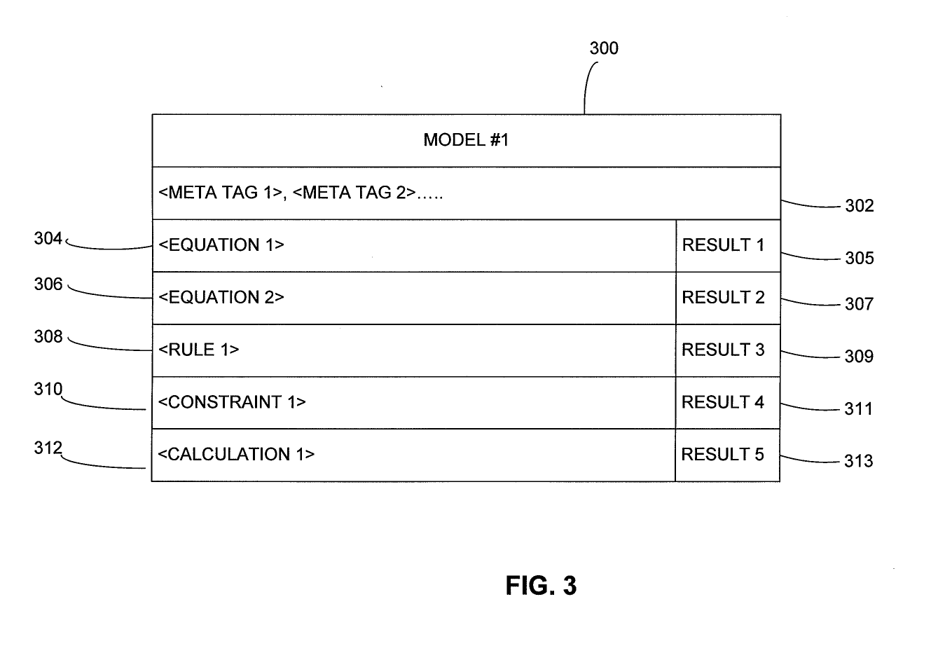

FIG. 3 is a sketch of a data structure string of a declarative model 300, such as one of model(s) 214 selected by model selector 210 of FIG. 2. Model 300 may be stored in any suitable way. In some embodiments, it may be stored in a file, and may be treated as a web page. Accordingly, in such embodiments, like other web pages, model 300 may include meta tags 302 to aid in indexing the model, such as in model index 212 of FIG. 2, thus relating the model to factors such as a query that are relevant to a search.

Model 300 may comprise one or more elements, which may define characteristics of information that may be returned to the user upon application of the model. In the illustrated embodiment, the elements may be statements in a declarative language. In some embodiments, the declarative language may be at a level that a human being who is not a computer programmer could understand and author. For example, it may contain statements of equations and the form of a result based on evaluation of the equation, such as equation 304 and result 305, and equation 306 and result 307. An equation may be a symbolic or mathematical computation over a set of input data.

Model 300 may also comprise statement(s) of one or more rules, such as rule 308 and the form of a result based on evaluation of the equation, such as rule result 309. The application of some types of rules may trigger a search to be performed, thereby collecting new information. According to some embodiments, when a model such as model 300 containing a rule, such as rule 308, is applied, such as by model application engine 216, the evaluation of the rule performed as part of the application of the model may generate a search query and trigger a search to be performed by the data search engine, such as search engine 204. Thus, in such embodiments, an Internet search may be triggered based on a search query generated by the application of a model to the search data. Though a rule may specify any suitable result. For example, a rule may be a conditional statement and a result that applies, depending on whether the condition evaluated dynamically is true or false. Accordingly, the result portion of a rule may specify actions to be conditionally performed or information to be returned or any other type of information.

Model 300 may also comprise statement(s) of one or more constraints, such as constraint 310 and result 311. A constraint may define a restriction that is applied to one or more values produced on application of the model. An example of a constraint may be an inequality statement such as an indication that the result of applying a model to data 208 retrieved from a search be greater than a defined value.

Model 300 may also include statements of one or more calculations to be performed over input data, such as calculation 312. Each calculation may also have an associated result, such as result 313. In this example, the result may label the result of the specified calculation 312 such that it may be referenced in other statements within model 300 or otherwise specifying how the result of the computation may be further applied in generating information to a user. Calculation 312 may be an expression representing a numerical calculation with a numerical value as a result, or any other suitable type of calculation, such as symbolic calculations. In applying model 300 to data 208 retrieved by a search engine, model application engine 216 may perform any calculations over data 208 that are specified in the model specification, including attempting to solve equations, inequalities and constraints over the data 208. In some embodiments, the statements representing equations, rules, constraints or calculations within a model may be interrelated, such that information generated as a result of one statement may be referenced in another statement within model 300. In such a scenario, applying model 300 may entail determining an order in which the statements are evaluated such that all statements may be consistently applied. In some embodiments, applying a model may entail multiple iterations during which only those statements for which values of all parameters in the statement are available are applied. As application of some statements generates values used to apply other statements, those other statements may be evaluated in successive iterations. If application of a statement in an iteration changes the value of a parameter used in applying another statement, the other statement will again be applied based on the changed values of the parameters on which it relies. Application of the statements in a model may continue iteratively in this fashion until a consistent result of applying all statements in the model occurs from one iteration to the next, achieving a stable and consistent result. Though, it should be recognized that any suitable technique may be used to apply a model 300.

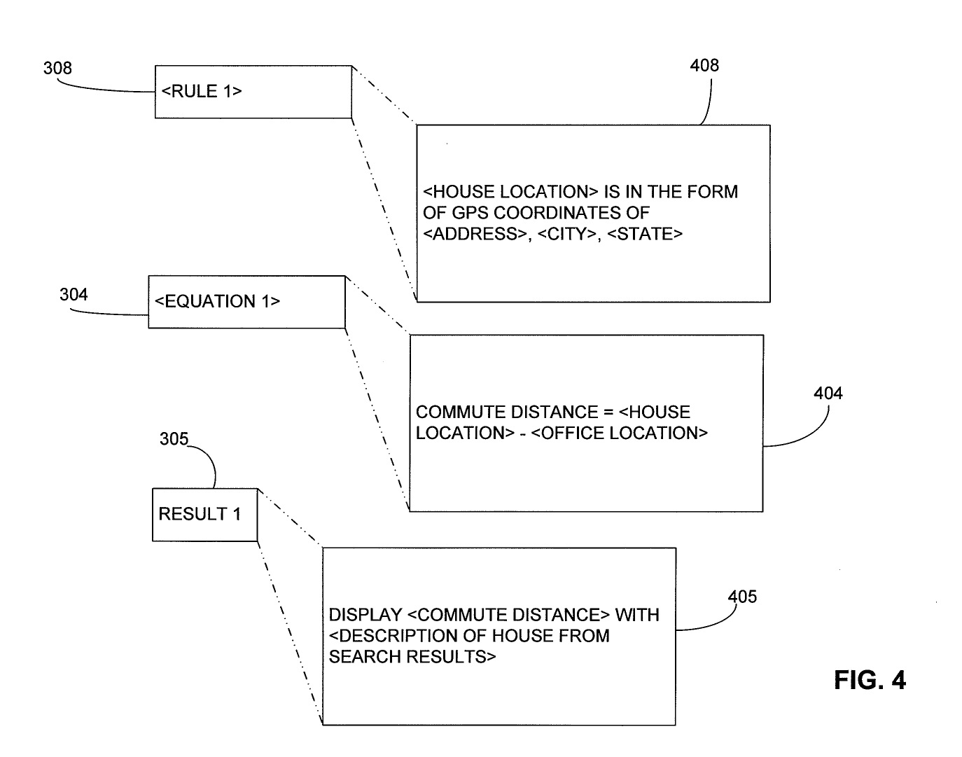

FIG. 4 provides an example of statements such as those that may be specified for model 300. In the example of FIG. 4, the model may be selected and applied when a user is performing a house search, and may in this example, relate houses for sale to the user's commute. Application of the model in the example of FIG. 4 may generate information on the commuting distance and/or time between each house for sale and the user's office location. Thus, rule statement 408 is an example of rule 308 from FIG. 3 that specifies the form of a house location to be used as part of the model computations. In this example, rule statement 408 specifies that a parameter, identified as a house location, be in the form of global positioning system (GPS) coordinates of the address, city and state of the house for sale. These parameters may, when the model is applied, be given values by model application engine 216 based on retrieved data 208. In this example, rule 308 may evaluate to true when a web page or other item of retrieved data contains information that is recognized as a house location by application of rule 308. Accordingly, rule 308 may be used to identify items of data for which other statements within the model are applied.

Equation statement 404 is an example of equation 304 of FIG. 3 that provides a computation to be performed to arrive at the commute distance, based on the location of the house for sale as specified in rule statement 408 and a value that may be available to model application engine 216, which in this example is indicated as the office location. In this example, the office location is an input parameter to the model that may have been provided, for example, as part of the user query, as part of the user's profile or user context. The house location, however, is based on the application of rule statement 408, received from another input to the model, such as data 208 that are returned as the result of the search engine.

Result statement 405 is an example of result 305 of FIG. 3 that specifies how to display the result of the computation performed for equation statement 404. Thus, result statement 405, in this example, specifies that the commute distance to each house for sale from the search results be displayed alongside the description of the house, which is a parameter for which a value may be established based on data 208.

The example of FIG. 4 illustrates some of the statements that may be present in a model to display results to a user query. In this example, the results relate to houses for sale. Accordingly, the model depicted in FIG. 4 may be selected by model selector 210 (FIG. 2) in response to a user query 202 requesting information on houses for sale. The model may be applied by model application engine 216 to every item of data in retrieved data 208. Though, not every retrieved item of data may comply with rule 308 or other conditions established by statements within the model. Accordingly, not every item of retrieved data 208 may be included in generated information 218. Though, FIG. 4 illustrates that other information, not expressly included within retrieved data 208, may be included in generated information 218. In the simple example of FIG. 4, a value of a parameter called “commute distance” is computed by model application engine 216 upon application of the model of FIG. 4.

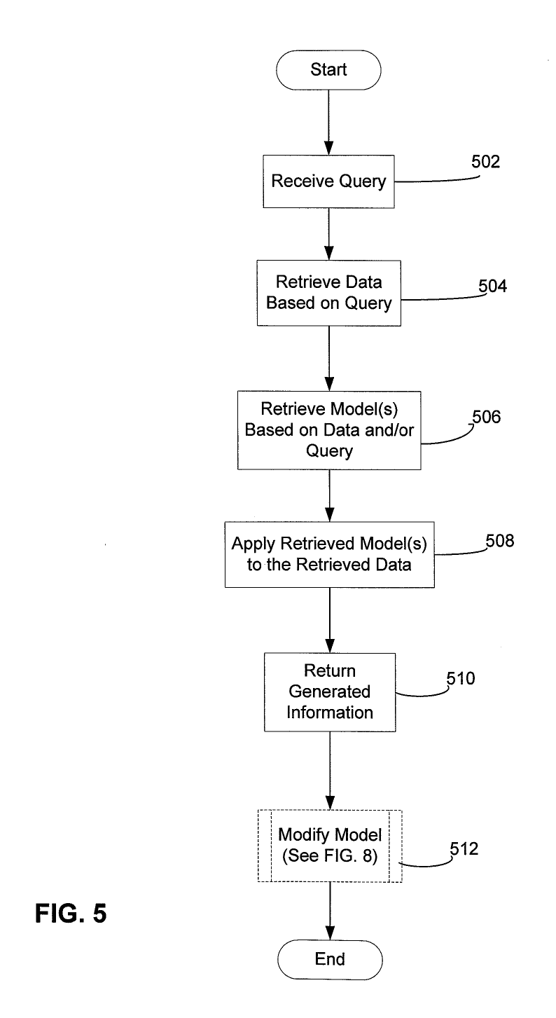

FIG. 5 is a flowchart of a process that may be performed during execution by a search stack, such as search stack 200 of FIG. 2 according to some embodiments. The process may start when a computing device, such as computing device 105 of FIG. 1, sends a search query on behalf of a user to a search engine, such as search engine 204 of FIG. 2. Though, it is not a requirement that the search process be triggered by express user input or express user input in textual form. Non-textual inputs or implied user inputs may be regarded as a query triggering execution of the process of FIG. 5.

In step 502, the search stack may receive the user's query. As discussed above, a user's query may be either implicit or explicit. For example, in some embodiments, a search stack may generate a search query on behalf of the user. The search stack, for example, may generate a search query based on context information associated with the user. This may be performed for example, by search engine 204 of FIG. 2.

Regardless of how the query is generated, in step 504, the search engine may then retrieve data matching the search results query. The data returned may be based on a match (whether explicit or implicit) between the query (and/or other factors, such as user context and a user profile) and terms in an index accessible to the search engine, such as data index 206 of FIG. 2.

The process then flows to step 506, in which the search stack may retrieve one or more models appropriate to the user's search. In the exemplary implementation of FIG. 2, appropriate model(s) may be selected by the model selector 210 in connection with an index (e.g., model index 212) relating a user's query and/or data returned by the search engine to one or more appropriate model(s).

At step 508, the search stack may then apply the retrieved model(s) to the retrieved data. In the exemplary implementation of FIG. 2, this step may be performed by model application engine 216. In addition to the retrieved data itself, other factors relating to the search such as the user query (or one or more portions thereof) may also serve as input to one or more computations performed as a result of applying the model on the retrieved data. Processing at step 508 may entail multiple iterations. In some embodiments, a model may apply to each item of data, such as a web page included in retrieved data 208. Accordingly, processing at step 508 may be iterative in the sense that it is repeated for each item contained within retrieved data 208. Alternatively or additionally, processing at step 508 may be iterative in that application of a model, whether applied to an individual item of data or a collection of items of data, may entail iteratively applying statements in the model until a stable and consistent result is achieved. Processing at step 508 may alternatively or additionally be iterative in the sense that multiple models may be selected by model selector 210 such that information in compliance with each of the selected models may be generated by processing at step 508.

Turning to step 510, the search stack may then output results generated as a result of the application of the selected model(s) to the retrieved data. In this example the output may entail returning information to a user computer which can then render the information on a display for a user. In some embodiments, the generated information may include some combination of the result of applying the model on the data returned from the search engine and the data itself. For example, the generated information may filter or reorder the search data based on the application of the model, or may provide additional information or information in a different format than the data returned by the search results. In some embodiments, the reordering of the search data may incorporate a time element. For example, a model may identify a time order of a set of multiple events. Application of such a model may then entail identifying search data related to those events, and generating the information returned to the user in an order in accordance to the time order of the model. Though, it should be recognized that the nature of the information generated may be in any suitable form that can be specified as a result of application of a model, which may contain a combination of elements, such as calculations, equations, constraints and/or rules.

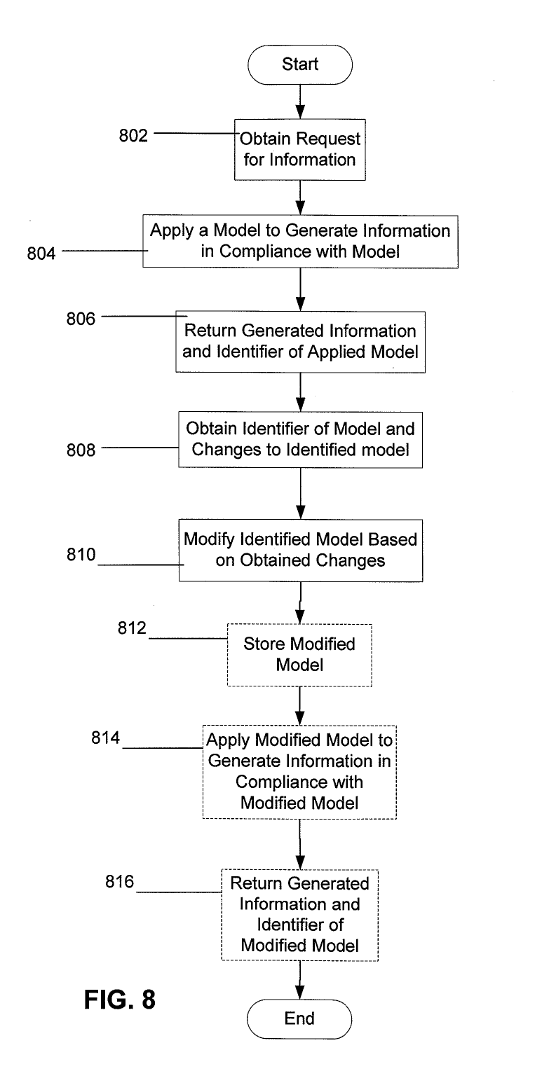

After the data is returned to the user (via the user's computing device), in some embodiments, at step 512, the user may optionally modify the model. More details for step 512 are described in FIG. 8 discussed below. The process of FIG. 5 may be done at this point.

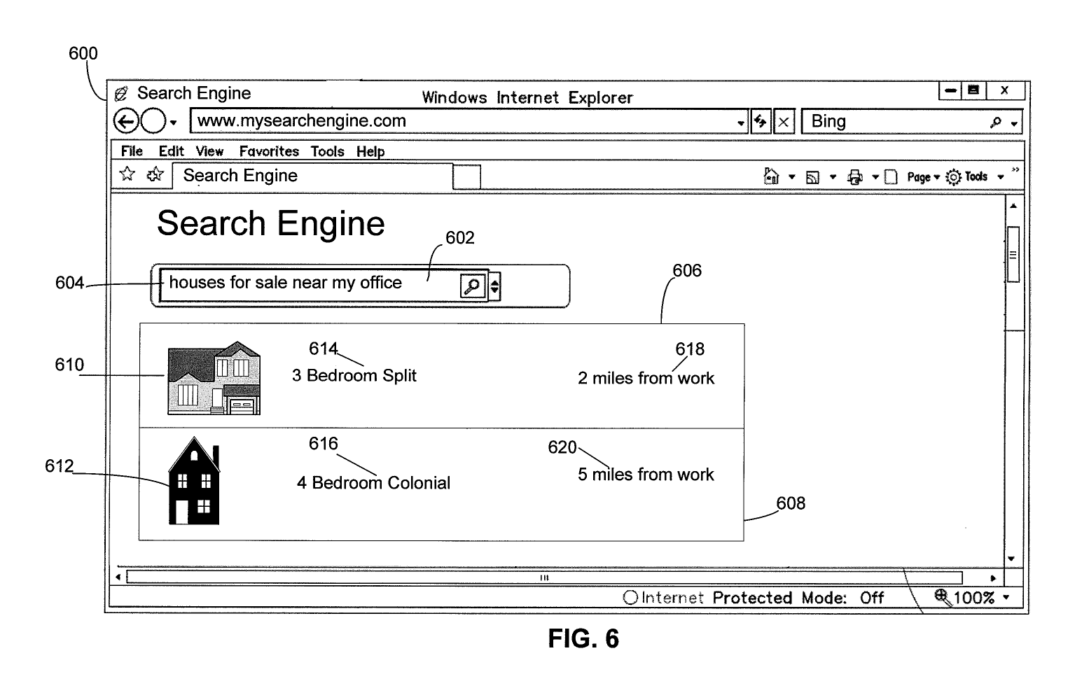

FIG. 6 is an example of a user interface via which a user may access a search in a retrieved system. In this example, a user may enter a search query and view information returned in response to the query. FIG. 6 illustrates that the interface is displayed by a web browser 600, although any suitable application to generate a user interface may be used. The web browser 600 may be any suitable web browser, illustrated in this example as being INTERNET EXPLORER® developed by Microsoft Corporation, and may execute on a computing device operated by the user (such as computing device 105 of FIG. 1). In the example of FIG. 6, the web browser has loaded a web page returned by a search and retrieval system such as that illustrated in FIG. 2.

The user has entered a text query 604, “houses for sale near my office,” in a query input field 602 in the user interface, and sent that query via web browser 600 to a search engine that is part of a search stack according to some embodiments. In response, the search stack returned generated information to the user via the web browser, illustrated in FIG. 6 as returned information elements 606 and 608, which are displayed in the web browser.

After receiving the user's query, the search engine may retrieve a set of data (e.g., web pages) including results of houses for sale near the user's office. The set of data returned from the search engine may be based on matches between the query terms and terms in an index relating to the web pages, as discussed above. Though, as illustrated, other sources of data may be used in evaluating the search query. In this example, the search query includes the phrase “my office.” That phrase may be associated with information in a user profile accessible to the search and retrieval system processing the query. Accordingly, on execution of the query, the search and retrieval system may filter results based on geographic location in accordance with the information specified in the user profile. Though, it should be recognized that any suitable technique may be used to process a search query and retrieve data.

Based on the query and/or the retrieved data, an appropriate model may then be selected by the search stack, such as by model selector 210 of FIG. 2. In the example of FIG. 6, the model specified in FIG. 4 relating houses for sale to a user's commute is selected based on the portion of the query text, “near my office.”

The selected model is then retrieved and applied to the data (i.e., the web pages of houses for sale) resulting from the search. The application of the model to the data may be performed, for example, by model application engine 216. In the example of FIG. 6, the user's office location may also be a value of an input parameter to the selected model. Because the query text “near my office” does not specify the exact office location, in this example, the user's office location may be taken from the user's profile or the user's context, for example. In this example, as discussed in connection with FIG. 4, applying the selected model comprises determining the GPS coordinates of the address, city and state of each house for sale from the search results, computing the commuting distance between each house and the user's office, and arranging the generated information to display the commuting distance alongside the description of each house for sale. In the example of FIG. 6, the display of the generated information has also been sorted based on commuting distance.

Thus, in the example of FIG. 6, two listings of houses for sale are returned by the search stack and displayed in the web browser, returned information elements 606 and 608. Each of returned information 606 and 608 includes a picture 610 and 612, respectively, of the house for sale and a description 614, and 616, respectively, of the house for sale. In addition, returned information elements 606 includes commuting information 618, “2 miles from work,” displayed alongside description 614, and returned information 608 includes commuting information 620, “5 miles from work,” displayed alongside description 616. In the example of FIG. 6, returned information elements 606 and 608 are returned as being sorted in ascending order based on commuting distance.

Accordingly, as the result of the application of the model specified by the example of FIG. 4, more useful information is returned to the user. That is, instead of merely returning a list of houses for sale, based on additional dynamic computations performed that are specific to the user or his query (i.e., based on his office location), performed based or dynamically identified data (houses for sale in this example), additional information (i.e., commute information) may be provided to the user than would otherwise be possible, and the results may be arranged accordingly. Accordingly, applying the selected model has allowed the user to receive additional information and presented in a manner that is more pertinent to his search query.

It may also be desirable to allow a user to further customize information returned in response to a request by modifying a model that may be applied to search results to generate such information. In some embodiments, a model may be modified iteratively in a process in which a user may see results of applying a selected model to results of a search query. The user may then modify the model and the system may present to the user results of applying the model as modified to results of the same query. Such an approach can be useful, for example, when the user has access to an existing model that may be adapted by the user, such that the user can see the results of modifying the model by adding new rules, equations, constraints, etc., to an existing model, or by editing such rules, equations, constraints, etc., in the existing model.

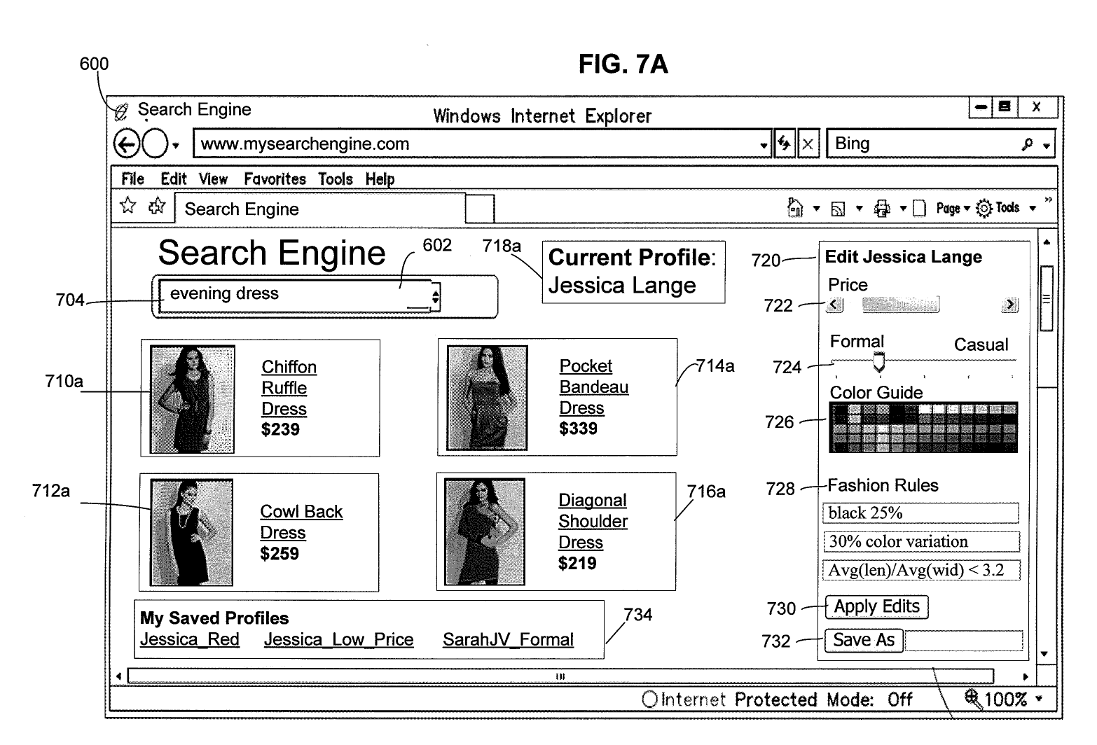

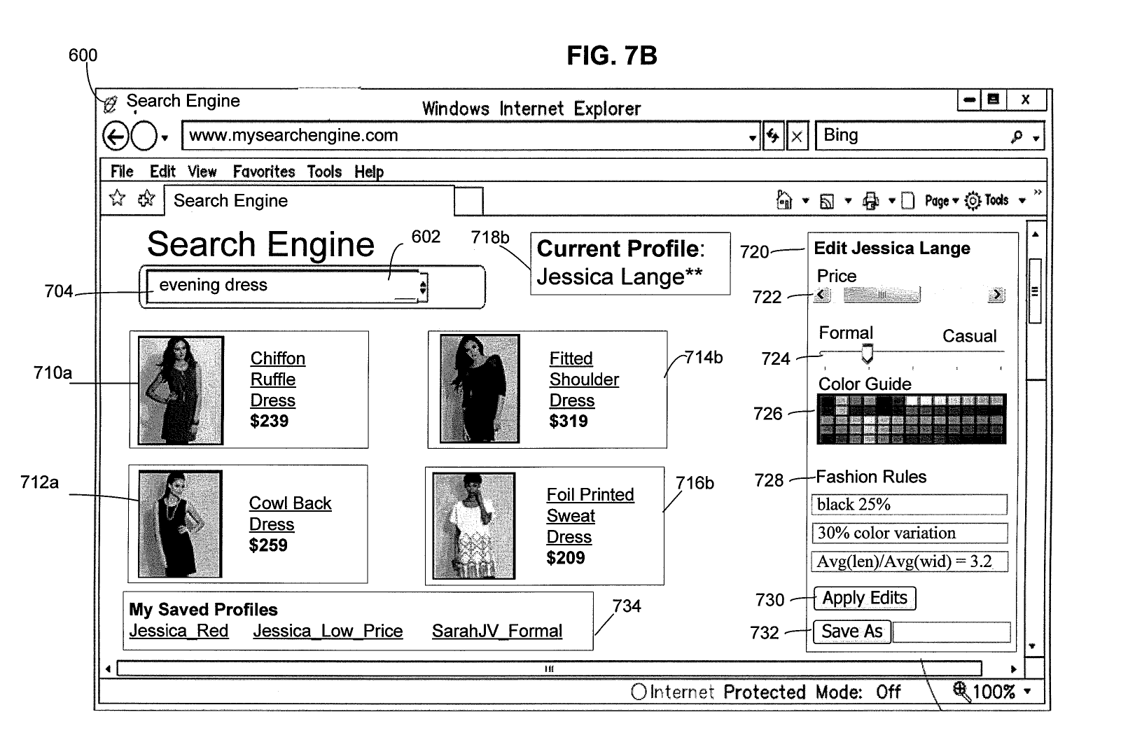

FIG. 7A is an example of a user interface via which a user may modify a model applied to generate information returned in response to a search query. FIG. 7A illustrates that the interface is displayed by web browser 600, which may be the same web browser as in FIG. 6, although any suitable application to generate a user interface may be used. In the example of FIG. 7A, web browser 600 has loaded a web page returned by a search and retrieval system such as that illustrated in FIG. 2.

The user has entered a text query 704, “evening dresses,” in query input field 602 in the user interface, and sent that query via web browser 600 to a search engine that is part of a search stack according to some embodiments. In response, the search stack returned generated information to the user via the web browser, illustrated in FIG. 7A as returned information elements 710a, 712a, 714a and 716a, which are displayed in web browser 600. In the example of FIG. 7A, each of returned information elements 710a, 712a, 714a and 716a includes a photo, description, and price of a dress for sale.

After receiving the user's query, the search engine may retrieve a set of data (e.g., web pages) including results of evening dresses. Prior to returning information to the user in response to the search query, a component of the search stack may apply a model to the set of data, so that the generated information may be in compliance with the model. In the example of FIG. 7A, a currently applied model 718a (e.g., “Jessica Lange”) was applied to the data, resulting in the generated information (e.g., returned information elements 710a, 712a, 714a and 716a) being in compliance with fashion preferences of Jessica Lange that are characterized in the model.

The user interface displayed in web browser 600 also includes model editing controls 720, which allow a user to modify currently applied model 718a. These may be any suitable type of controls. Even though in some embodiments, a model may be specified as a set of expressions or declarative statements, model editing controls 720 may allow for editing the model in a graphical manner, rather than being limited to editing expressions. In such embodiments, the user interface or other components of a search stack may convert or translate back and forth between declarative statements that may comprise a model specification and aspects of the model specification that may be varied and expressed in a more graphical form.

For example, FIG. 7A includes slide bar controls 722 and 724 of two different styles. In this example, slide bar control 722 allows modification of a price range of dresses in compliance with the model. Thus, in this example, dragging the slide bar to the left or the right may increase or decrease the overall price range of dresses in compliance with the model. User actuation of this control may be translated to a declarative statement. For example, editing component 262 may translate an input entered via a slider control to a declarative statement in the form of, “price must be between $100 and $400.”

Any suitable aspects of the specification of the model that characterize information to be returned when a model is applied may be defined in this way. In some embodiments, the width of the range, that is, the difference between the lower limit (e.g., least expensive dress) and the upper limit (e.g., most expensive dress) may also be adjusted by adjusting the corresponding width of the slide bar. Slide bar control 724, in this example, however is of a different style, because it does not illustrate a range with a lower and upper limit, but instead allows a user to specify a point in a continuum. In some embodiments, the specified point in the continuum may correspond to a range of a predetermined width in the model specification, or it may correspond to a single value. Slide bar control 724, in this example, allows a user to modify the relative formality of dresses in compliance with the model. That is, dresses may be categorized in a continuum between “formal” and “casual.” In this example, editing component 262 may translate the user input to declarative statements such as, “information relates to item classified as ‘casual,’” with a corresponding result portion indicating that when the statement is true for some information, that information is returned to the user. The categorization may be made in any suitable way. For example, it may be specified in the data to be searched or it may be calculated by expressions in the model that analyze the data to be searched to infer a categorization for the data. Model editing controls 720 also include a color picker control 726 that may allow the user to select one or more colors and/or ranges of colors for dresses that are in compliance with the model.

As another example of model editing controls 720, FIG. 7A also includes expression text fields 728. These may allow a user to input a new expression for the model which may comprise an additional part of the model specification. In some embodiments, an expression entered in expression text fields 728 may be in the expected format of a model specification, thus allowing a user to have significant control over the editing of a model. Additionally and/or alternatively, an expression may be entered in a format different (e.g., natural language input) from the expected format of a model specification, in which it is then translated by a component in the search stack to the expected format. In addition to allowing a user to add new expressions to a model specification, expression text fields 728 may also display and allow a user to edit expressions that are in the current model specification.

After modifying a model using model editing controls 720, the model, as modified by the changes, may be applied to generate information in compliance with the modified model. The generation of new information in compliance with the modified model may be triggered in any suitable way. In some embodiments, new information may be generated immediately upon detecting user input via model editing controls. For example, upon sliding one of slide bar controls 722 or 724 may trigger an immediate generation of new information based on the change in the model due to the input from the respective slide bar control. As another example, as a user types in a new expression or edits an expression from currently applied model 718a, new information may be automatically generated to reflect the change in the model. In some embodiments, including that illustrated by FIG. 7A, the triggering of the generation of new information in compliance with the modified model may be performed in response to user selection of an apply edits control 730, which may be any suitable control, including a button control, as illustrated in FIG. 7A.

FIG. 7B is an example of the user interface (e.g., web browser 600) of FIG. 7A in a subsequent state in which a modified model has been applied to generate information returned to the user. The user may have made any suitable modifications to the model using any one or more of the above-discussed model editing controls 720. Thus, FIG. 7B illustrates a situation after the user has modified currently applied model 718a via model editing controls 720 and has selected apply edits control 730. Accordingly, information has been generated and returned to the user in compliance with the modified model. Thus, information generated in compliance with the new model that is displayed in the user interface of FIG. 7B includes some information (e.g., returned information elements 710a and 712a) that also complied with the original model, and some new information (e.g., returned information elements 714b and 716b). Because the model being currently applied is a modification of the original model, an indication of that fact is presented to the user. This may be done in any suitable way, including as in the example of FIG. 7A, in which “**” characters are appended to the identifier for the original model, resulting in a new identifier (e.g., “Jessica Lange**”) for currently applied model 718b.

Upon making changes to a model, a user may additionally save the modifications made to the model. Accordingly, FIGS. 7A and 7B provide a save model control 732, which in this example, allows a user to enter an identifier (e.g., name) for the modified model. It is to be appreciated that any suitable identifier for a model may be used, including a number, an image and/or picture, sound, etc. In some embodiments, in response to user selection of save model control 732 a new model corresponding to the modified model may then be created, and may be stored in any suitable location, for example, in computer storage media associated with some component of the search stack, such as on a local client (e.g., computing device 105) for the user who modified the model or in pool of models 250 in the search system. The new model may then be applied to process subsequent search queries.

In embodiments in which models may be centrally stored, such as in pool of models 250, access controls may be associated with a model to restrict which users may have access to the model as part of processing a search query for the user. For example, based on the access controls, the new model may be made only available to the current user (i.e., the user who modified the original model), or it may be shared with any suitable group of users (e.g., anyone or the current user's friends).

FIGS. 7A and 7B illustrate several models that were customized by the current user and saved as new models (e.g., user saved models 734). In this example, the user has already created two customized versions of the “Jessica Lange” profile, that is, “Jessica Red” and “Jessica Low Price,” and has also create a customized version of another profile, that is, “SarahJV Formal.” Although not illustrated in FIGS. 7A and 7B, in some embodiments, by making modifications to a model, a user may be allowed to replace the original model with the modified model. For example, a user may be allowed to replace a model that the user himself created, either from scratch, or by modifying and saving an existing model under a new identifier. By allowing a user to create a new model by starting from an existing model and editing that existing model, less burden is placed on the user rather than environments in which a new model may only be created from scratch.

FIG. 8 is a flowchart of a process of modifying a model that may be carried out by an information retrieval system, such as by the components of the search stack 200 illustrated in FIG. 2. The process of FIG. 8 may provide more details of step 512 of FIG. 5. The process may begin at step 802, in which the information retrieval system may obtain a request for information from a user. This may be done in any suitable way, including search engine 204 receiving a user query, as discussed above. In response to the request, the information retrieval system may generate a body of information, such as by executing a search query in a conventional way.

At step 804, the information retrieval system may apply a model to that body of data generated in response to the request for information obtained in step 802. This step may be performed, for example, by model application engine 216, as discussed above. Though, in some embodiments, the body of data may be transferred to a client computer where a similar model application engine may operate.

At step 806, the information retrieval system may then return to the user the information generated in step 804 based on the application of the model. The process at step 806 may also involve returning to the user an identifier of the model that was applied to generate the information in step 804. The information may be returned to the user by displaying the information using a web browser, though any suitable output mechanism may be used.

At step 808, the information retrieval system may obtain changes to a model. This may be performed, for example, by model editing component 262 of FIG. 2. For example, model editing component 262 may render a user interface, such as the user interface of FIGS. 7A and 7B, which may be displayed through a browser or through a client computer. In some embodiments, in addition to the changes to the model, an identifier of the model being changed may also be obtained. In some embodiments, the changes may be obtained during a query session. For example, the changes to the model may be obtained in the same query session as that of steps 802, 804 and 806 in which the request for information is processed. The model being changed may be the same model that was applied to generate the search results in step 804, or it may be a different model specified by the user. The model changes and the model identifier may be obtained in any suitable way, including via a suitable telecommunications network from a client, such as computing device 105, via any suitable interface, including that illustrated in FIGS. 7A and 7B.

The model changes may be in any suitable format. For example, they may constitute a complete specification of a new model in the format of a set of expressions that define the new model. Model changes may additionally or alternatively be communicated in a different format as a model specification. For example, model changes may be communicated as a change to an aspect of the specification of the model. A change to an aspect of the specification of the model may involve addition or deletion of an aspect of the specification that is used in identifying information consistent with the model, and/or it may involve a change in value or in a range of values associated with an aspect of the specification of the model. For example, according to the example of FIGS. 7A and 7B, an aspect of a specification of the model may correspond to acceptable colors and/or ranges of colors, so that only data for dresses associated with the acceptable colors or color ranges may be displayed to the user. The values of this aspect specified by the model may be changed so that subsequent application of the model generates information relating to dresses of a different color.

Though, the model may be changed in other ways, such as by deleting the color aspect from the model. In this case, information identified by application of the model does not depend on color of an item to which the information relates. As another example, a change may add an aspect. For example, an aspect relating to fabric could be added and a value identifying cotton could be assigned to that aspect. In this case, subsequent application of the model may return information about items that are made of cotton.

Thus, in the example of FIGS. 7A and 7B, the model changes to aspects of the specification of the model may specify a new price range, new colors, and/or new formality criteria for the modified model. Model changes may also be in the form of additional or modified expressions, such as those entered via expression text fields 728 of FIGS. 7A and 7B.

At step 810, the identified model is then modified based on the obtained changes. This step may involve creating a new model based on the original model and the obtained changes but leaving the original model intact, or it may involve actually changing the original model. When the model changes are not in the format of a model specification, model editing component 262 or any suitable other component of the search stack may first translate or convert the model changes into expressions in the appropriate format of a model specification before the model is modified.

At step 812, the process may involve optionally storing the modified model. This may be done in any suitable way. For example, a new model representing the original model may be added to pool of models 250, and/or the original model (if stored in pool of models 250) may be replaced in pool of models 250 by the modified model. Storage of the modified model may include an identification of a user who modified the model and/or an indication of access rights to the modified model. For example, an indication may be stored specifying which users (e.g., current user only, friends of the current user, anyone, etc.) may have access to the modified model for use in the application to search results. In some embodiments, models may alternatively or additionally be stored local to a client (e.g., computing device 105) of the information retrieval system. In such embodiments, in step 812, a specification for the modified model may be transmitted to the client for storage on the client. The modified model may be stored on the client in any suitable way, including in a web browser cookie. When the model is stored on the client, it may be used, for example, in situations in which the client sends the model to the information retrieval system along with a request for information, so that the model may then be applied by the information retrieval system. A model stored on the client may also be used in situations in which the client itself applies the model to information retrieved from a search engine, in order to generate the information displayed to the user.

At step 814, the process may optionally involve applying the modified model to generate information in compliance with the modified model. This step may be performed automatically upon obtaining the changes to the model, or it may be performed in response to an additional message or command from the user. The information may be generated in response to a request for information obtained from the user. The request for information may have been previously obtained, such as at step 802, before the changes to the model were obtained in step 810. In such embodiments, the information retrieval system may have already returned information to the user in response to the request for information based on an application of the original, unmodified model, such as at step 804. In such embodiments, data that was retrieved from a search engine in response to the request for information in step 802 and over which the original model was applied at step 804 may be cached by the information retrieval system. Thus, at step 814, the modified model may be applied to the cached data, obviating the need to retrieve the data again using the search engine. Additionally or alternatively, a new request for information may have been newly obtained after or around the same time as the changes to the model were obtained, in which case the search engine may retrieve a new set of data over which to apply the modified model.

At step 816, the process may optionally involve returning the information generated based on the application of the modified model to the user. Optionally, an identifier of the modified model may also be transmitted to the user, indicating for example, that the modified model rather than the original model was applied to generate the returned information.

The process of FIG. 8 may be done at this point. It should be appreciated, however, that while not so illustrated in FIG. 8, the process of FIG. 8 may repeat back to step 808, in which additional changes to the modified model may be obtained, and/or in which changes to a different model may be obtained. Thus, the model may be edited in an iterative fashion, in which changes to the model may be immediately applied to data retrieved from the search engine (which may be cached, as discussed above), and new information generated as a result of applying the modified model may be displayed to the user in “real time.”

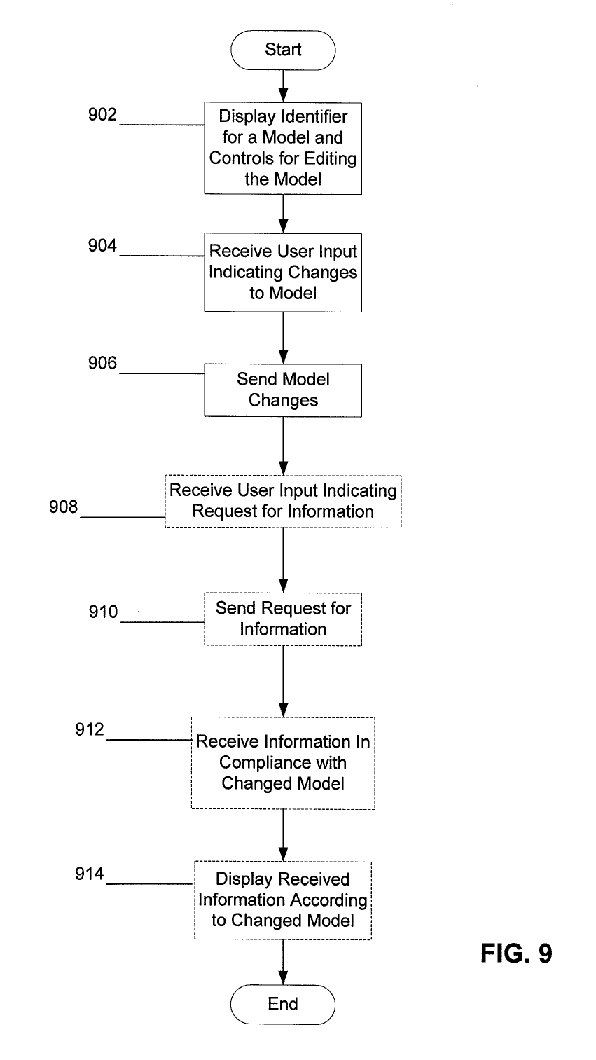

FIG. 9 is a flowchart of a process of modifying a model that may be carried out by a client of an information retrieval system. The process may be carried out, for example, by computing device 105 via the user interface of FIGS. 7A and 7B. The process may begin at block 902, in which controls may be displayed for editing the model. The display of the controls may be done in any suitable way. For example, the display may be controlled by software executing on a client, such as computing device 105, or it may be controlled by one or more pages received from a server and rendered in a web browser on the client. Any suitable controls may be displayed, including those described in connection with FIGS. 7A and 7B. Optionally, an identifier for the model may also be displayed, so that the user may be aware of which model is being edited.

At step 904, the process may receive user input indicating changes to the model. This may be done in any suitable way, including via types of controls described in connection with FIGS. 7A and 7B. Proceeding to step 906, model changes based on the user input received in step 904 are then sent to the information retrieval system. The model changes may be in any suitable format, including those discussed above. Part of step 906 may include translating and/or converting the format of the changes from the format received as input to another format, including a format of a model specification.

Optionally, at step 908, user input indicating a request for information may also be received by the client. The request for information may be in any suitable format, including those discussed above, and be received in any suitable way, including for example, via query input field 602 of FIGS. 7A and 7B. At step 910, the client may optionally send the request for information received via the user input in step 908 to the information retrieval system.

At step 912, the client optionally may then, in response to the request for information, receive from the information retrieval system information in compliance with the model as changed according to the sent changes. At step 914, the client optionally may then display the information returned in step 912, for example, via the user interface illustrated in FIGS. 7A and 7B. The process of FIG. 9 may then be done at this point. It is to be appreciated, however, that, while not illustrated as such, the process of FIG. 9 may repeat. For example, the process may repeat back to step 902 or 908.

It is also to be appreciated that at least some of the steps of the process of FIG. 9 may be performed in a different order than that implied by the flowchart diagram. For example, steps 908 and/or 910 may have been performed at an earlier point in the process, even prior to step 902. For example, the receipt of user input indicating a request for information may have been received around the same time as the receipt of user input indicating changes to a model of step 904, and the sending of the request for information may have been performed around the same time as the sending of changes to the model at step 906. As an additional example, in some embodiments, the client may have received a request for information from the user, sent that request to the informal retrieval system, and received and displayed information returned in response to the request prior to step 902. In such embodiments, steps 912 and 914 may be performed based on the initial request for information that was sent prior to step 902. However, in other situations, a user may enter and send a request for information in steps 908 and 910 that is different from any request for information that may have been sent to the information retrieval system prior to step 902, in which case steps 912 and 914 may be performed based on the new request for information.

Furthermore, data retrieved by a search engine in response to a search query may be cached anywhere in the search stack, including in the information retrieval system, in a client, or anywhere in between. When the data is cached on a client computer, such as computing device 105, the application of a model to the data may be performed on the client computer. Thus, the model may be stored on the client, or may have been transmitted to the client by the information retrieval system. In such embodiments, software executing on the client may not only modify a model, but also apply the modified model to the cached data to generate information returned and displayed to the user of the client. Thus, by allowing the client to itself apply the model to cached data returned from a prior request for information, such embodiments obviate the need for back and forth communication between the client and the information retrieval system in order to view the result of applying a modified model to a previously performed request for information. This may be particularly useful when the client is a mobile computing device, in which a significant portion of time may be expended in transmitting search results from a search engine to the client. By caching the results on the client, the transmission of search results may only need to be performed once, while the application of a modified model to the search results may be performed multiple times in an iterative fashion on the client, thereby yielding improved response time or reduced data charges from a cellular service provider providing wireless communication services for the mobile device.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. At least one non-transitory computer storage medium comprising computer-executable instructions, that when executed by at least one processor, perform a method of operating an information retrieval system, the method comprising:
obtaining changes to a model characterizing information to be returned in response to a search query;
modifying the model based on the obtained changes; and
applying the modified model to search results to generate information in compliance with the modified model.

2. The at least one non-transitory computer storage medium of claim 1, wherein the method further comprises:
storing the modified model in a pool of models to replace a previously defined model.

3. The at least one non-transitory computer storage medium of claim 1, wherein the method further comprises:
storing the modified model in a pool of models as a new model.

4. The at least one non-transitory computer storage medium of claim 1, wherein:
the method further comprises obtaining a request for information from a user; and
applying the modified model to generate information in compliance with the modified model comprises applying the modified model to search results retrieved in response to the request for information to generate information in compliance with the modified model.

5. The at least one non-transitory computer storage medium of claim 4, wherein the method further comprises:
returning the generated information to the user.

6. The at least one non-transitory computer storage medium of claim 1, wherein obtaining changes to a model comprises obtaining during a query session changes to aspects of a specification of the model.

7. The at least one non-transitory computer storage medium of claim 1, wherein obtaining changes to a model comprises obtaining from a user a declarative statement comprising at least part of a specification for the model.

8. The at least one non-transitory computer storage medium of claim 1, wherein the method further comprises:
obtaining an identifier for the model; and
prior to modifying the model, retrieving the model from a pool of models based on the identifier.

9. The at least one non-transitory computer storage medium of claim 1, wherein the model comprises at least one declarative statement, wherein a declarative statement comprises at least one of a group of statements consisting of a constraint, an equation, an inequality, a calculation, and a rule.

10. A method of performing a search with an information retrieval system, the method comprising:
operating at least one processor to perform acts comprising:
displaying at least one control for modifying a model, wherein the model specifies expressions to be applied to search results to generate information in compliance with the model;
receiving via the controls user input indicating modifications to the model; and
sending to the information retrieval system the indicated modifications to the model.

11. The method of claim 10, wherein the at least one control for modifying the model comprises a plurality of controls, each control of the plurality of controls for modifying a respective aspect of a specification of the model.

12. The method of claim 10, wherein the at least one control for modifying the model comprises a text input field for receiving a new expression comprising at least a portion of a specification of the model.

13. The method of claim 10, wherein the method further comprises:
receiving user input indicating a request for information;
sending the request for information to the information retrieval system; and
receiving information from the information retrieval system in response to the request, the information being in compliance with the indicated modifications to the model.

14. The method of claim 10, wherein:
sending to the information retrieval system the indicated modifications to the model comprises sending an identifier for the model and changes to the identified model.

15. The method of claim 10, wherein:
the method further comprises generating a new model based on the received modifications to the model; and
sending to the information retrieval system the indicated modifications to the model comprises sending the new model to the information retrieval system.

16. A system for interacting with an information retrieval system, the system comprising:
at least one processor configured to display a user interface, the user interface being adapted to:
receive user input specifying a search query;
display a first set of information generated in response to the search query, the first set of information being derived based on a model defining characteristics of information;
receive user input indicating modifications to the model; and
display a second set of information generated in response to the search query, the second set of information being in compliance with the model incorporating the modifications.

17. The system of claim 16, wherein:
the user interface is further adapted to:
display an identifier of the model; and
display a text input field; and
receiving user input indicating modifications to the model comprises receiving a new declarative statement via the text input field, the new declarative statement comprising a portion of a definition of the characteristics of the information for the identified model.

18. The system of claim 16, wherein:
the user interface is further adapted to:
display an identifier of the model; and
display a plurality of controls for editing the identified model, each control of the plurality of controls for modifying a respective aspect of a specification of the model.

19. The system of claim 18, wherein at least one of the displayed controls comprises a slider bar for modifying an acceptable lower value and upper value of an aspect of a specification of the model.

20. The system of claim 18, wherein the at least one control comprises a color picker for selecting one or more colors.
